(19) United States
(12) Patent Application Publication
(10) Pub. No.: US 2009/0163058 A1
(43) Pub. Date: Jun. 25, 2009

(54) ELECTRICAL CONNECTOR WITH TETHERED COVER

(76) Inventors: Darrell Wayne Craig, Stokesdale, NC (US); Christine Anne Dooley, Lewisville, NC (US); Joseph E. Geniac, Greensboro, NC (US)

Correspondence Address: Lisa Burgin Vaccarelli;Tyco Technology Resources, Suite 140, 4550 New Linden Hill Road, Wilmington, DE, 19808, US

(21) Appl. No.: 12/338,465

(22) Filed: Dec. 18, 2008

Related U.S. Application Data
(60) Provisional application No. 61/008,799, filed on Dec. 21, 2007.
(60) Provisional application No. 61/070,914, filed on Mar. 26, 2008.

(51) Int. Cl. H01R 13/40

(52) U.S. Cl. 439/147

(57) ABSTRACT

An electrical connector assembly includes a connector having a housing and a receptacle for mating with a mating connector. The assembly also includes a cover configured to attach to the housing, and a tether linking the housing to the cover. The tether includes a housing mount for installing the tether onto the housing, a cover mount for installing the tether onto the cover, and a link connecting the housing mount to the cover mount. The link is non-metallic.

This application claims priority to and the benefit of the filing dates of U.S. Provisional Application No. 61/008,799, filed on Dec. 21, 2007 and U.S. Provisional Application No. 61/070,914, filed Mar. 26, 2008, both of which are hereby incorporated by reference in their entirety.

### BACKGROUND OF THE INVENTION

The subject matter described and/or illustrated herein relates generally to electrical connectors, and, more particularly, to electrical connectors having tethered covers.

Electrical connectors that are commonly used in telecommunication systems provide an interface between successive runs of cables and/or between cables and electronic devices of the system. Some of such electrical connectors, for example modular jacks, include a receptacle for receiving a mating plug therein. For example, the mating plug may terminate the end of a cable. In some applications, the receptacle may be mounted to a wall, panel, equipment surface, and/or the like. In some of these applications, it is desirable to protect the receptacle from the environment. Specifically, it may be desirable to protect the receptacle from dust, dirt, and/or other debris when the plug is not mated to the receptacle. Thus, the receptacle may be installed within a connector housing. In certain applications, a removable cover may be provided on the housing to cover the receptacle when the electrical connector is not in use, for example, when the mating plug is not plugged into the receptacle. The cover provides a barrier that prevents or reduces dust, dirt, and/or other debris from collecting within the receptacle. At least some known covers include a tether that connects the cover to the housing of the electrical connector. The tether facilitates preventing the cover from being lost or misplaced when removed from the housing.

The tethers of at least some known electrical connectors may be more difficult and/or expensive to manufacture and/or assemble than may be desired. For example, the tethers of at least some known electrical connectors may include a plurality of components, such as a pair of connection rings, a chain, and/or one or more gaskets. Each of the connection rings surrounds a portion of either the housing or the cover to provide connection thereto. The chain connects the connection rings together to tether the cover to the housing. Gasket(s) may be provided between the connection rings and adjacent portions of the electrical connector and/or other structures, such as a panel to which the housing is mounted. The multiple components may increase the difficulty and/or cost of assembling and/or manufacturing the tether and/or the associated electrical connector. Further, the chain may be fabricated from a plurality of beads or links that are connected together, which may increase a complexity of the chain and thereby may increase the difficulty and/or cost of manufacturing the tether. Moreover, the connection rings and chain of at least some known tethers are metallic, which may increase a cost and/or difficulty of manufacturing the tether.

### BRIEF DESCRIPTION OF THE INVENTION

In one embodiment, an electrical connector assembly includes a connector having a housing and a receptacle for mating with a mating connector. The assembly also includes a cover configured to attach to the housing, and a tether linking the housing to the cover. The tether includes a housing mount for installing the tether onto the housing, a cover mount for installing the tether onto the cover, and a link connecting the housing mount to the cover mount. The link is non-metallic.

Optionally, the housing mount and/or the cover mount is non-metallic. The link optionally includes an elongate strip. The cover mount and/or the housing mount optionally includes at least a portion of a ring. Optionally, the housing mount includes an opening for installing the housing mount on the housing and/or the cover mount includes an opening for installing the cover mount on the cover. The housing includes a mating end portion and the housing mount optionally fits over the mating end portion of the housing. The cover includes a mating end portion and the cover mount optionally fits over the mating end portion of the cover.

In some embodiments, the housing includes a housing groove and the housing mount includes a tab configured to be received within the housing groove. Optionally, the housing mount includes an opening for installing the housing mount onto the housing and a tab extending generally toward a center of the opening. Optionally, the cover includes a cover groove and at least a portion of the cover mount is configured to be received within the cover groove. Optionally, the cover mount includes a recess and the cover includes a rib that is configured to be received within the recess. In some embodiments, the cover includes an opening and the cover mount includes a tip portion of the link, wherein the tip portion is configured to be received within the opening of the cover. Optionally, the tip portion includes a latch feature configured to latch the tip portion within the opening of the cover. Optionally, the housing mount includes a tab extending a length along a longitudinal tab axis, wherein the link extends a length along a longitudinal link axis that is angled obliquely relative to the longitudinal tab axis.

### BRIEF DESCRIPTION OF THE DRAWINGS

FIG. 1 is an exploded perspective view of an exemplary embodiment of an electrical connector assembly and an exemplary panel.

FIG. 2 is a perspective view of an exemplary embodiment of a housing of the electrical connector assembly shown in FIG. 1.

FIG. 3 is a perspective view of an exemplary embodiment of a cover of the electrical connector assembly shown in FIG. 1.

FIG. 4 is an elevational view of the cover shown in FIG. 3 illustrating an exemplary embodiment of an arrangement of a plurality of ribs of the cover.

FIG. 5 is a plan view of an exemplary embodiment of a tether of the electrical connector assembly shown in FIG. 1.

FIG. 6 is a perspective view of the electrical connector assembly and panel shown in FIG. 1 assembled.

FIG. 7 is an exploded perspective view of an exemplary alternative embodiment of an electrical connector assembly and an exemplary panel.

FIG. 8 is a perspective view of an exemplary embodiment of a cover of the electrical connector assembly shown in FIG. 7.

FIG. 9 is a plan view of an exemplary embodiment of a tether of the electrical connector assembly shown in FIG. 7.

FIG. 10 is a perspective view of the electrical connector assembly and panel shown in FIG. 7 assembled.

### DETAILED DESCRIPTION OF THE INVENTION

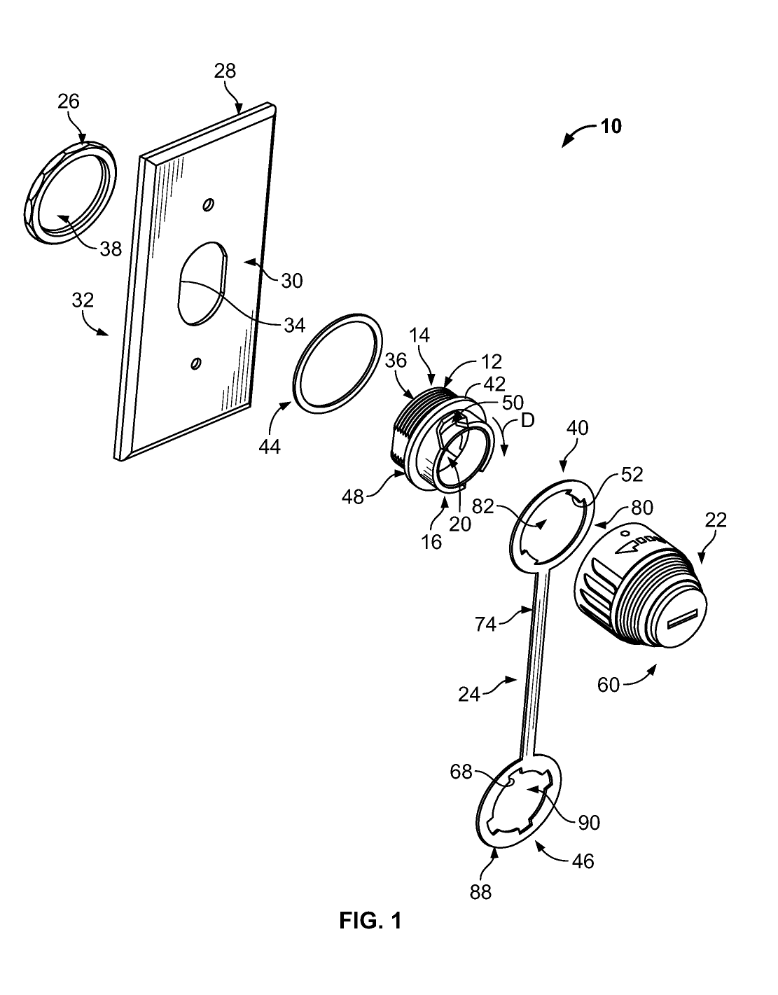

FIG. 1 is an exploded perspective view of an exemplary embodiment of an electrical connector assembly 10 and an exemplary panel 28. In the exemplary embodiment, the electrical connector assembly 10 includes a modular receptacle (not shown), such as, but not limited to, an RJ-45 outlet or jack. However, the electrical connector assembly 10 may include any type of receptacle. The electrical connector assembly 10 is configured for mating with a mating connector (not shown), such as, but not limited to, a mating plug that may be received within the receptacle. The electrical connector assembly 10 includes a connector 12 having a housing 48 and the receptacle. The housing 48 includes a mounting end portion 14 and a mating end portion 16. The housing 48 includes a flange 42 between the mounting end portion 14 and the mating end portion 16, respectively. The housing 48 includes an opening 20 extending therethrough from the mounting end portion 14 to the mating end portion 16. The receptacle is held within the opening 20 of the housing 48 such that a mating interface (not shown) of the receptacle is positioned along the mating end portion 14 of the housing 48. Accordingly, the receptacle receives the mating connector therein through the mating end portion 16 of the housing 48.

The electrical connector assembly 10 includes the connector 12, a cover 22, a tether 24, an optional gasket 44, and a fastener 26. As shown in FIG. 1, the electrical connector assembly 10 is mounted on an exemplary panel 28. Although the panel 28 is a faceplate, the electrical connector assembly 10 may be mounted on any type of panel. The panel 28 includes a pair of opposite sides 30 and 32 and an opening 34 extending therethrough. The opening 34 receives the mounting end portion 14 of the housing 48 for mounting the housing 48 on the panel 28. Specifically, when received within the opening 34, the mounting end portion 14 of the housing 48 extends from the side 32 of the panel 28. The fastener 26 can then be connected to the mounting end portion 14 of the housing 48 to secure the panel 28 between the fastener 26 and the flange 42, and thereby secure the housing 48 to the panel 28. Optionally, the gasket 44 extends between the side 30 of the panel 28 and the flange 42 of the housing 48. The opening 34 may have any geometr(ies), size(s), shape(s), and/or the like.

In the exemplary embodiment, the mounting end portion 14 of the housing 48 includes a plurality of threads 36 that threadably engage a plurality of threads 38 of the fastener 26 to connect the housing 48 and the fastener 26 together. In addition or alternative to the threads 36 and/or 38, the housing 48 and/or the fastener 26 may include any other type of structure, means, and/or the like for mounting the housing 48 on the panel 28 using any type of connection between the housing 48 and the panel 28 and/or the fastener 26, such as, but not limited to, a bayonet connection, an interference connection, a snap-fit connection, and/or the like. In some embodiments, the fastener 26 is not included and the housing 48 connects directly to the panel 28.

The cover 22 is removably connected to the housing 48. When connected to the housing 48, the cover 22 covers the mating end portion 16 of the housing 48 such that the cover 22 covers the mating interface of the receptacle. The cover 22 provides a barrier that prevents or reduces dust, dirt, and/or other debris from collecting within the receptacle. The cover 22 may be removed from the housing 48 to expose the receptacle and enable mating of the mating connector with the connector 12. The tether 24 includes a housing mount 40 and a cover mount 46. As will be described below, the housing mount 40 is mounted on the housing 48 and the cover mount 46 is mounted on the cover 22 to connect the cover 22 to the housing 48. The tether 24 thereby facilitates preventing the cover 22 from being lost or misplaced when removed from the housing 48.

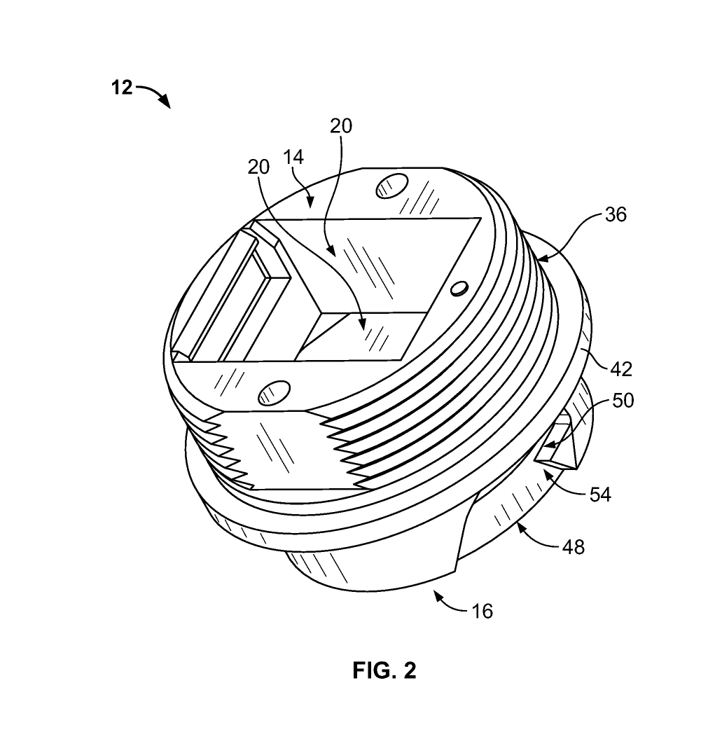

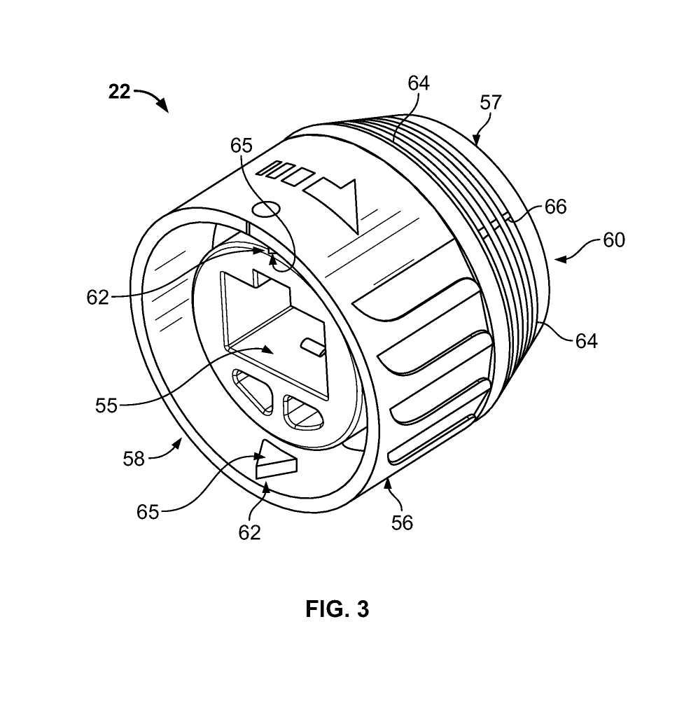

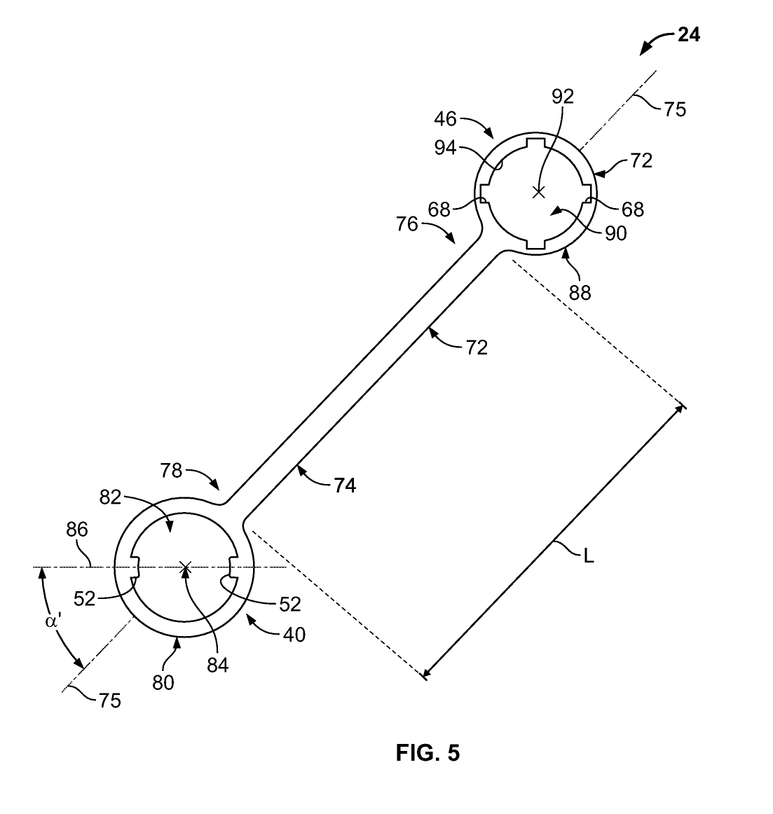

FIG. 2 is a perspective view of an exemplary embodiment of the housing 48. In the exemplary embodiment, the mating end portion 16 of the housing 48 includes one or more bayonet connection features 54 that cooperate with corresponding bayonet connection features 62 (FIG. 3) of the cover 22 (FIGS. 1, 3, 4, and 6) for removably attaching the cover 22 to the housing 48. Each housing bayonet connection feature 54 includes a housing groove 50 that receives an extension 65 (FIG. 3) of the corresponding cover bayonet connection feature 62 therein. As will be described below, each housing groove 50 also receives a corresponding tab 52 (FIGS. 1 and 5) of the housing mount 40 (FIGS. 1 and 5) of the tether 24 (FIGS. 1, 5, and 6) therein. In addition or alternative to the bayonet connection features 54 and/or 62, other types of structure, means, and/or the like for connection of the cover 22 to the housing 48, such as, but not limited to, a threaded connection, an interference connection, a snap-fit connection, and/or the like, may be used. Although, in the exemplary embodiment, the housing 48 includes two bayonet connection features 54 arranged approximately opposite each other (approximately 180° from each other) along an exterior surface of the mating end portion 16, the housing 48 may include any number of bayonet connection features 54 each having any location along the exterior surface of the mating end portion 16 relative to any other bayonet connection feature 54.

FIG. 3 is a perspective view of an exemplary embodiment of the cover 22. The cover 22 includes a body 56 having a mating end portion 58 and an opposite end portion 60. The cover body 56 includes an optional opening 55 extending therein. The opening 55 optionally holds a dummy plug (not shown) that is received in the receptacle when the cover 22 is attached to the housing 48 (FIGS. 1, 2, 6, 7, and 10). The dummy plug facilitates aligning the cover 22 with the housing 48 during attachment of the cover 22 to the housing 48. As the cover 22 is removed from the housing 48, the dummy plug is removed from the receptacle to expose the receptacle for reception of the mating connector therein.

The mating end portion 58 of the cover body 56 connects to the housing 48. Accordingly, at the mating end portion 58, the cover body 56 includes one or more bayonet connection features 62 for removably attaching the cover 22 to the housing 48. Specifically, each bayonet connection feature 62 of the cover body 56 cooperates with a corresponding one of the bayonet connection features 54 of the housing 48 to connect the cover 22 from the housing 48. As described above, each bayonet connection feature 62 includes an extension 65. Although, in the exemplary embodiment, the cover body 56 includes two bayonet connection features 62 arranged approximately opposite each other (approximately 180 from each other) along an internal surface of the mating end portion 58, the cover body 56 may include any number of bayonet connection features 62 each having any location along the internal surface of the mating end portion 58 relative to any other bayonet connection feature 62. As described above, other structures may be used in lieu of the bayonet type attachment mechanism.

The end portion 60 of the cover body 56 includes one or more cover grooves 64 along at least a portion of the outer surface 57 of the end portion 60. As will be described below, one of the cover grooves 64 receives the cover mount 46 (FIGS. 1 and 5) of the tether 24 (FIGS. 1, 5, and 6) to mount the tether 24 on the cover 22. Each cover groove 64 includes one or more of ribs 66. As will be described below, each rib 66 of the cover groove 64 that receives the cover mount 46 therein is received within a corresponding recess 68 (FIGS. 1 and 5) of the cover mount 46 of the tether 24. As can be seen in FIG. 3, the outer surface 57 of the end portion 60 is sloped such that each groove 64 is located at a different diameter of the outer surface 57.

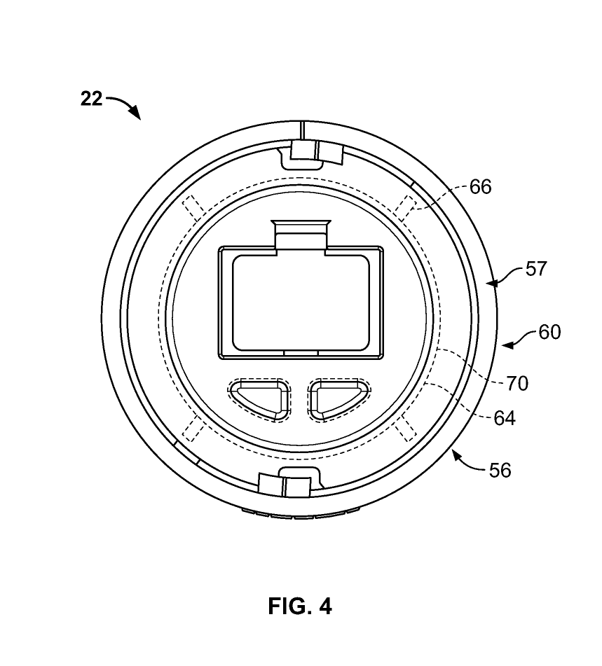

FIG. 4 is an elevational view of the cover 22 illustrating an exemplary embodiment of an arrangement of the ribs 66 along the outer surface 57 of the end portion 60 of the cover body 56. For clarity, only one cover groove 64 is shown in FIG. 5. The cover groove 64 and the ribs 66 thereof are shown with phantom lines in FIG. 5. Each cover groove 64 extends into the cover body 56 a depth to a bottom 70. Each rib 66 extends outwardly from the bottom 70 of the corresponding cover groove 64. In the exemplary embodiment, each rib 66 extends along only a portion of the depth of the corresponding cover groove 64. Alternatively, one or more of the ribs 66 extends along an approximate entirety of the depth of the corresponding cover groove 64. In the exemplary embodiment, the ribs 66 are arranged along the outer surface 57 of the end portion 60 of the cover body 56 such that each cover groove 64 includes four ribs 66 that are located approximately 90° from each adjacent rib 66 of the same cover groove 64. However, the ribs 66 of each cover groove 64 may have any locations along the outer surface 57 of the end portion 60 of the cover body 56 relative to any other rib 66 of the same cover groove 64. Moreover, each cover groove 64 may include any number of ribs 66.

Referring now to FIGS. 3 and 4, the cover body 56 may include any number of cover grooves 64. Moreover, any of the cover grooves 64 may receive the cover mount 46 of the tether 24 therein. Any of the cover grooves 64 that do not receive the cover mount 46 of the tether 24 therein may not include some or any of the ribs 66 thereof.

FIG. 5 is a plan view of an exemplary embodiment of the tether 24. The tether 24 includes a body 72 having the cover mount 46 and the housing mount 40. As described above, the cover mount 46 mounts the tether 24 to the cover 22 (FIGS. 1, 3, 4, and 6) and the housing mount 40 mounts the tether 24 to the housing 48 (FIGS. 1, 2, 6, 7, and 10). A link 74 extends between, and connects, the cover mount 46 and the housing mount 40. In the exemplary embodiment, the link 74 is an elongate strip that extends a length L along a longitudinal axis 75 between a cover mount end portion 76 and a housing mount end portion 78. The cover mount end portion 76 extends from the cover mount 46, and the housing mount end portion 78 extends from the housing mount 40. The longitudinal axis 75 of the link 74 may be referred to herein as a “longitudinal link axis”.

In the exemplary embodiment, the housing mount 40 includes a continuous ring 80 having an opening 82 extending therethrough. The opening 82 includes a center 84. The opening 82 is configured to receive a portion of the mating end portion 16 (FIGS. 1 and 2) of the housing 48 therein such that the ring 80 fits over a portion of the housing 48. Specifically, in the exemplary embodiment, the ring 80 fits over the exterior surface of the mating end portion 16 of the housing 48. As described above, the housing mount 40 includes one or more tabs 52. Specifically, each tab 52 extends radially inward from the ring 80 generally toward the center 84. As described above and will be described below, each tab 52 is received within a corresponding one of the housing grooves 50 (FIGS. 1, 2, and 7) of the housing 48. In the exemplary embodiment, the housing mount 40 includes two tabs 52 that are arranged approximately opposite each other (approximately 180° from each other) along the ring 80. Specifically, each tab 52 extends a length from the ring 80 along a common longitudinal tab axis 86. The longitudinal axis 75 of the link 74 optionally extends at any oblique angle \acute{α} relative to the longitudinal tab axis 86. As will be described below, when the housing mount 40 is mounted on the housing 48, the oblique angle \acute{α} between the longitudinal axis 75 of the link 74 and the longitudinal tab axis 86 facilitates locking the tether 24 to the housing 48.

Although two tabs 52 are shown, the housing mount 40 may include any number of the tabs 52 for reception within any number of housing grooves 50. Although the tabs 52 are arranged approximately opposite each other (approximately 180° from each other) along the ring 80 in the exemplary embodiment, each tab 52 may have any location along the ring 80 relative to any other tab 52 so long as each tab 52 is aligned with the corresponding housing groove 50. Moreover, the optional oblique angle of the longitudinal axis 75 of the link 74 may be relative to the longitudinal tab axis of any of the tabs 52 when the ring 80 includes two tabs 52 that are not aligned along a common longitudinal tab axis.

In the exemplary embodiment, the cover mount 46 includes a continuous ring 88 having an opening 90 extending therethrough. The opening 90 includes a center 92. The opening 90 is configured to receive a portion of the end portion 60 (FIGS. 3, 4, and 6) of the cover 22 therein such that the ring 88 fits over a portion of the cover 22. Specifically, in the exemplary embodiment, the ring 88 is received within one of the grooves 64 (FIGS. 3 and 4) of the cover 22. As described above, the cover mount 46 includes the recesses 68. Specifically, the recesses 68 extend within a radially inner surface 94 of the ring 88. As described above and will be described below, each recess 68 receives a corresponding one of the ribs 66 (FIGS. 3 and 4) of the cover 22. In the exemplary embodiment, the cover mount 46 includes four recesses 68 that are arranged along the ring 88 approximately 90° from each adjacent recess along the ring 88. However, the cover mount 46 may include any number of recesses 68, each for reception of any number of ribs 66. Moreover, each recess 68 may have any location along the ring 88 relative to any other recess 68

The tether body 72 may be fabricated from any material(s), so long as the link 74 is non-metallic. As used herein, the term “non-metallic” as applied to an item is intended to mean that such item does not include a metal. Optionally, the housing mount 40 and/or the cover mount 46 are non-metallic. In some embodiments, an entirety of the tether body 72 is non-metallic. Examples of one or more materials that any portion of the tether body 72 may be fabricated from include, but are not limited to, plastics and/or other polymers, such as, but not limited to, thermoplastics, such as, but not limited to, acrylonitrile butadiene styrene (ABS), acrylic, celluloid, ethylene vinyl alcohol (EVAL), fluoroplastics, ionomers, liquid crystal polymer (LCP), polyacetal (POM), polyacrylates, polyamide (PA), polyamide-imide (PAI), polyaryletherketone (PAEK), polybutylene terephthalate (PBT), polyethylene terephthalate (PET), polycarbonate (PC), polyketone (PK), polyester, polyethylene, polyetheretherketone (PEEK), polyetherimide (PEI), polyimide (PI), polylactic acid (PLA), polypropylene (PP), polystyrene (PS), polysulfone (PSU), polyvinyl chloride (PVC), and/or the like. Moreover, further examples of one or more materials that any portion of the tether body 72 may be fabricated from include, but are not limited to, non-polar plastics such as, but not limited to, fluroopolymers, polytetrafluoroethylene (PTFE), polyethylene (PE), and/or the like. Even more examples of one or more materials that any portion of the tether body 72 may be fabricated from include, but are not limited to, extruded plastics (such as, but not limited to, extruded polystyrene and/or the like), thermosets (such as, but not limited to, phenol formaldehyde resin, duroplast, polyester, and/or epoxy), and/or the like. In the exemplary embodiment, the housing and cover mounts 40 and 46, respectively, are formed integrally with the link 74. Alternatively, the housing mount 40 and/or the cover mount 46 is formed separately from the link 74.

Although each of the rings 80 and 88 of the housing mount 40 and the cover mount 46, respectively, are shown as having an approximately circular shape, each of the rings 80 and/or 88 may include any other shape(s) in addition or alternative to approximately circular, such as, but not limited to, an approximately rectangular shape and/or the like. Moreover, although each ring 80 and 88 is shown as continuous, one or more of the rings 80 and/or 88 may alternatively not be continuous such that the ring 80 and/or 88 does not continuously surround the mating end portion 16 of the housing 48 and/or the end portion 60 of the cover 22, respectively.

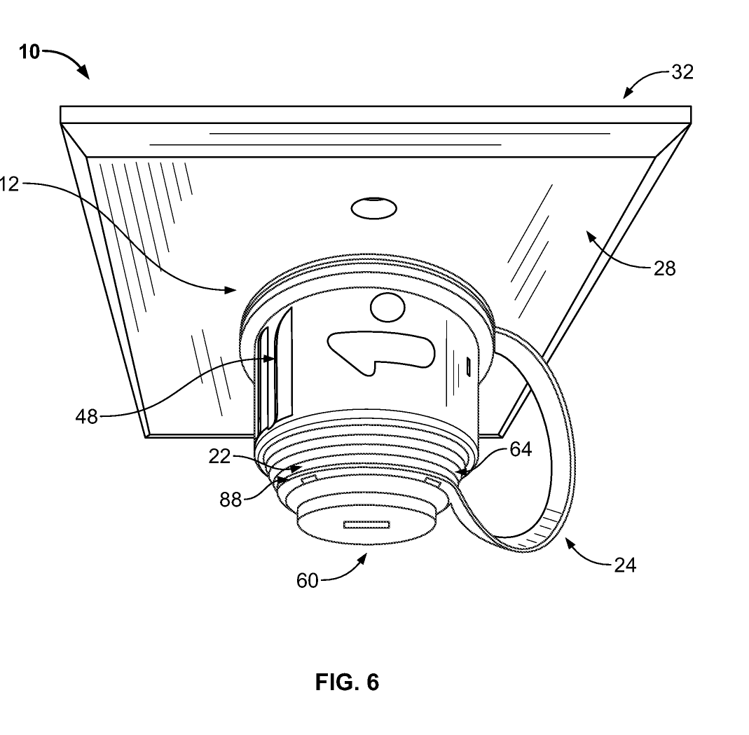

FIG. 6 is a perspective view of the electrical connector assembly 10 and panel 28 assembled. Referring now to FIGS. 1 and 6, to assemble the electrical connector assembly 10 and mount the electrical connector assembly 10 on the panel 28, the mounting end portion 14 of the housing 48 is inserted into the opening 34 within the panel 28. The gasket 44 is optionally sandwiched between the flange 42 and the panel 28. On the side 32 of the panel 28, the fastener 26 is connected to the mounting end portion 14 of the housing 48, via the threads 36 and 38, to mount the housing 48 to the panel 28.

To mount the tether 24 to the cover 22, the ring 88 of the cover mount 46 is fit over the end portion 60 of the cover 22 such that the ring 88 is received within one of the cover grooves 64. Moreover, the ring 88 is positioned such that each recess 68 of the ring 88 receives a corresponding one of the ribs 66 (FIGS. 3 and 4) of the cover 22. Engagement between the ribs 66 and the recesses 68 facilitates locking the tether 24 to the cover 22. To mount the tether 24 to the housing 48, the ring 80 of the housing mount 40 is fit over the mating end portion 16 of the housing 48. The ring 80 is fit over the mating end portion 16 such that the each tab 52 of the ring 80 is received within the corresponding housing groove 50 of the housing 48. Reception of the tabs 52 within the housing grooves 50 facilitate locking the tether 24 to the housing 48 via engagement of the tabs 52 with the housing 48, and more specifically with surfaces of the housing 48 that define the housing grooves 50. The tether 24 thereby facilitates preventing the cover 22 from being lost or misplaced when removed from the housing 48.

When the tether 24 is mounted on the housing 48 and the cover 22, and the cover 22 is mounted on the housing 48, the tabs 52 are sandwiched within the housing grooves 50 between the housing 48 and the extensions 65 (FIG. 3) of the cover 22 to facilitate locking the tether 24 to the housing 48. A thickness of the housing mount 40 is such that the housing mount 40 does not interfere with the bayonet connection between the cover 22 and the housing 48. Moreover, the oblique angle \acute{α} between the longitudinal axis 75 (FIG. 5) of the link 74 and the longitudinal tab axis 86 (FIG. 5) of the tabs 52 facilitates locking the tether 24 to the housing 48. Specifically, the oblique angle acts as a moment arm that provides a force in the direction D of FIG. 1 to facilitate keeping the tether 24 attached to the housing 48. The force in the direction D may be provided by a weight of the link 74, the cover mount 46, and/or the cover 22, and/or may be provided by an orientation of the cover mount 46 relative to the cover 22. For example, when the cover 22 is removed form the housing 48, the weight of the cover 22 provides the force in the direction D to facilitate keeping the tether 24 attached to the housing 48.

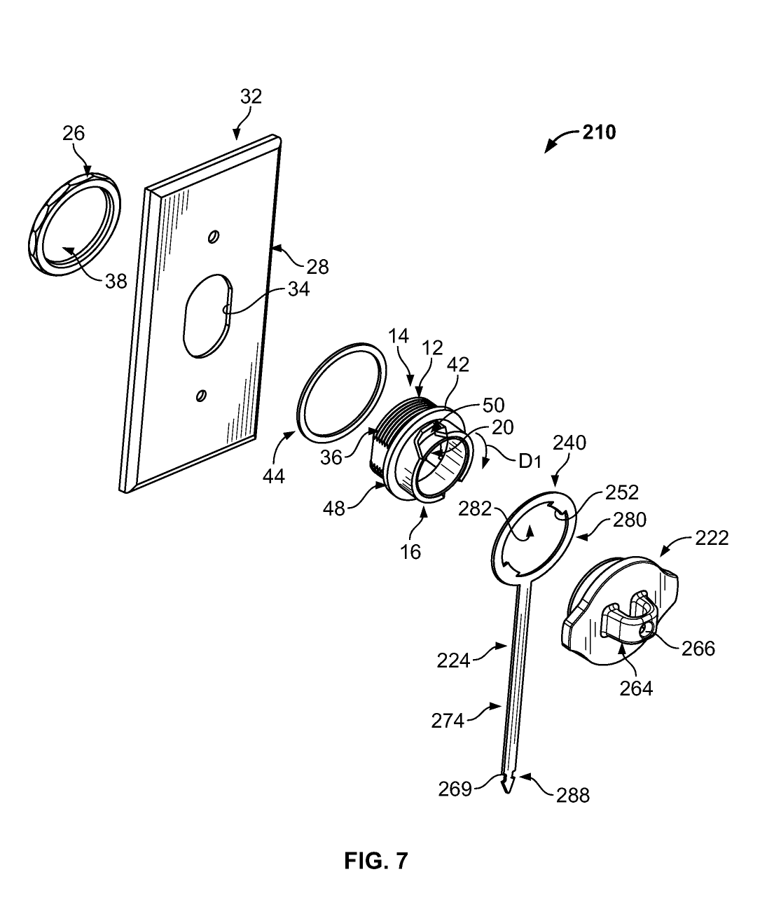

FIG. 7 is an exploded perspective view of an exemplary alternative embodiment of an electrical connector assembly 210 and the exemplary panel 28. In the exemplary embodiment, the electrical connector assembly 210 includes the modular receptacle, such as, but not limited to, an RJ-45 outlet or jack. However, the electrical connector assembly 210 may include any type of receptacle. The electrical connector assembly 210 is configured for mating with the mating connector, such as, but not limited to, a mating plug that may be received within the receptacle.

The electrical connector assembly 210 includes the connector 12, a cover 222, a tether 224, the fastener 26, and the optional gasket 44. As shown in FIG. 7, the electrical connector assembly 210 is mounted on the exemplary panel 28, although the electrical connector assembly 210 may be mounted on any type of panel. Connection between the housing 48 and the fastener 26, as well as mounting of the housing 48 on the panel 28, is substantially similar to that described herein with respect to the electrical connector assembly 10 (FIGS. 1 and 6) and therefore will not be described in more detail herein with respect to the electrical connector assembly 210.

The cover 222 is removably connected to the housing 48. When connected to the housing 48, the cover 222 covers the mating end portion 16 of the housing 48 such that the cover 222 covers the mating interface of the receptacle. The cover 222 provides a barrier that prevents or reduces dust, dirt, and/or other debris from collecting within the receptacle. The cover 222 may be removed from the housing 48 to expose the receptacle and enable mating of the mating connector with the connector 12.

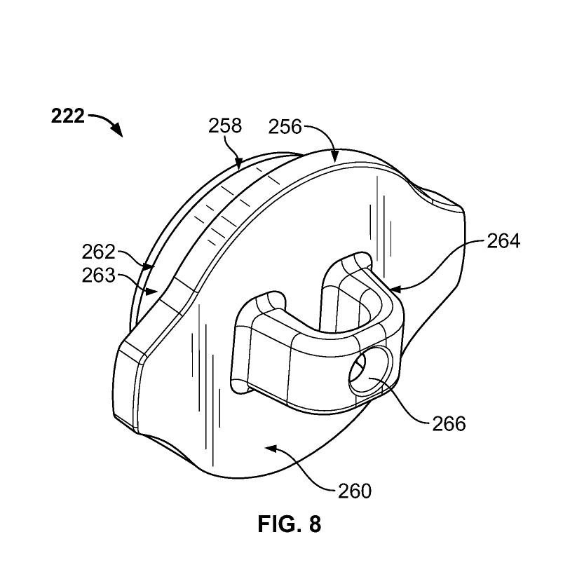

FIG. 8 is a perspective view of an exemplary embodiment of the cover 222. The cover 222 includes a body 256 including an end portion 258 and an end portion 260. The end portion 258 connects to the housing 48 (FIGS. 1, 2, 6, 7, and 10). Specifically, the end portion 258 of the cover 222 is configured to be received within the opening 20 (FIGS. 1, 2, and 7) of the housing 48 and includes a connection feature 262 that communicates with an internal surface of the mating end portion 16 (FIGS. 1, 2, and 7) of the housing 48 to connect the cover 222 to the housing 48. In addition or alternative to the connection feature 262, the cover 222 may include any other type of structure, means, and/or the like for connection to the housing 48, such as, but not limited to, a threaded connection, a snap-fit connection, an interference connection, a bayonet connection, and/or the like. In the exemplary embodiment, the connection feature 262 is a groove 263 that extends within an exterior surface of the end portion 258 of the cover 222 and receives an o-ring (not shown) therein. The o-ring engages the internal surface of the mating end portion 16 of the housing 48 to facilitate holding the end portion 258 of the cover 222 within the opening 20 of the housing 48. In addition or alternative to the groove 263, the connection feature 262 may include any other type of connection feature.

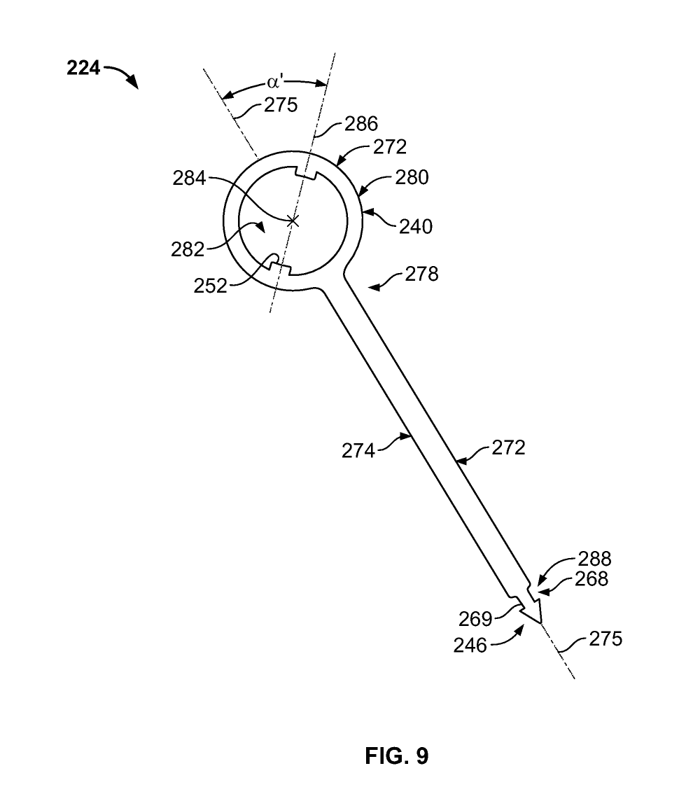

At the end portion 260, the cover body 256 includes an extension 264 having an opening 266. In the exemplary embodiment, the opening 266 extends through the extension 264. As will be described below, the opening 266 receives at least a portion of a cover mount 246 (FIGS. 7 and 9) of the tether 224 (FIGS. 7, 9, and 10) therein to mount the tether 224 on the cover 222. Although the opening 266 is shown as having an approximately cylindrical shape, the opening 266 may include any other shape(s) in addition or alternative to approximately cylindrical.

FIG. 9 is a plan view of an exemplary embodiment of the tether 224. The tether 224 includes a body 272 including the cover mount 246 and a housing mount 240. The cover mount 246 mounts the tether 224 to the cover 222 (FIGS. 7, 8, and 10) and the housing mount 240 mounts the tether 224 to the housing 48 (FIGS. 1, 2, 6, 7, and 10). A link 274 extends between, and connects, the cover mount 246 and the housing mount 240. In the exemplary embodiment, the link 274 is an elongate strip that extends a length along a longitudinal axis 275 from the cover mount 46 to a housing mount end portion 278, which extends from the housing mount 240. The longitudinal axis 275 of the link 724 may be referred to herein as a “longitudinal link axis”.

In the exemplary embodiment, the housing mount 240 includes a continuous ring 280 having an opening 282 extending therethrough. The opening 282 includes a center 284. The opening 282 is configured to receive a portion of the mating end portion 16 (FIGS. 1, 2, and 7) of the housing 48 therein such that the ring 280 fits over a portion of the housing 48. Specifically, in the exemplary embodiment, the ring 280 fits over the exterior surface of the mating end portion 16 of the housing 48. The housing mount 240 includes one or more tabs 252. Specifically, each tab 252 extends radially inward from the ring 280 generally toward the center 284. As will be described below, each tab 252 is received within a corresponding one of the housing grooves 50 (FIGS. 1, 2, and 7) of the housing 48. In the exemplary embodiment, the housing mount 240 includes two tabs 252 that are arranged approximately opposite each other (approximately 180° from each other) along the ring 280. Specifically, each tab 252 extends a length from the ring 280 along a common longitudinal tab axis 286. The longitudinal axis 275 of the link 274 optionally extends at any oblique angle \acute{α} relative to the longitudinal extension axis 286. As will be described below, when the housing mount 240 is mounted on the housing 48, the oblique angle \acute{α} between the longitudinal axis 275 of the link 274 and the longitudinal tab axis 286 facilitates locking the tether 224 to the housing 48.

Although two tabs 252 are shown, the housing mount 240 may include any number of the tabs 252 for reception within any number of housing grooves 50. Although the tabs 252 are arranged approximately opposite each other (approximately 180° from each other) along the ring 280 in the exemplary embodiment, each tab 252 may have any location along the ring 280 relative to any other tab 252. Moreover, the optional oblique angle \acute{α} of the longitudinal axis 275 of the link 274 may be relative to the longitudinal tab axis of any of the tabs 252 when the ring 280 includes two tabs 252 that are not aligned along a common longitudinal tab axis.

Although the ring 280 of the housing mount 240 is shown as having an approximately circular shape, the ring 280 may include any other shape(s) in addition or alternative to approximately circular, such as, but not limited to, an approximately rectangular shape and/or the like. Moreover, although the ring 280 is shown as continuous, the ring 280 may alternatively not be continuous such that the ring 280 does not continuously surround the mating end portion 16 of the housing 48.

The cover mount 246 includes a tip portion 288 of the link 274. As will be described below, the tip portion 288 is configured to be received within the opening 266 (FIGS. 7, 8, and 10) of the extension 264 (FIGS. 7, 8, and 10) of the cover 222 to mount the tether 224 on the cover 222. The tip portion 288 includes a latch feature 268 that cooperates with the extension 264 to latch the tip portion 288 within the opening 266. In the exemplary embodiment, the latch feature 268 includes one or more recesses 269 that each receive a portion of the extension 264 therein to latch the tip portion 288 within the opening 266. In addition or alternative to the recesses 269, the latch feature 268 may include any other structure, means, and/or the like for latching the tip portion 288 within the opening 266. Although two recesses 269 are shown, the latch feature 268 may include any number of recesses 269.

The tether body 272 may be fabricated from any material(s), so long as the link 274 is non-metallic. Optionally, the housing mount 240 and/or the cover mount 246 are non-metallic. In some embodiments, an entirety of the tether body 272 is non-metallic. Examples of one or more materials that any portion of the tether body 272 may be fabricated from include, but are not limited to, rubbers and/or plastics and/or other polymers, such as, but not limited to, thermoplastics, such as, but not limited to, acrylonitrile butadiene styrene (ABS), acrylic, celluloid, ethylene vinyl alcohol (EVAL), fluoroplastics, ionomers, liquid crystal polymer (LCP), polyacetal (POM), polyacrylates, polyamide (PA), polyamide-imide (PAI), polyaryletherketone (PAEK), polybutylene terephthalate (PBT), polyethylene terephthalate (PET), polycarbonate (PC), polyketone (PK), polyester, polyethylene, polyetheretherketone (PEEK), polyetherimide (PEI), polyimide (PI), polylactic acid (PLA), polypropylene (PP), polystyrene (PS), polysulfone (PSU), polyvinyl chloride (PVC), and/or the like. Moreover, further examples of one or more materials that any portion of the tether body 272 may be fabricated from include, but are not limited to, non-polar plastics such as, but not limited to, fluroopolymers, polytetrafluoroethylene (PTFE), polyethylene (PE), and/or the like. Even more examples of one or more materials that any portion of the tether body 272 may be fabricated from include, but are not limited to, extruded plastics (such as, but not limited to, extruded polystyrene and/or the like), thermosets (such as, but not limited to, phenol formaldehyde resin, duroplast, polyester, and/or epoxy), and/or the like. In the exemplary embodiment, the housing and cover mounts 240 and 246, respectively, are formed integrally with the link 274. Alternatively, the housing mount 240 and/or the cover mount 246 is formed separately from the link 274.

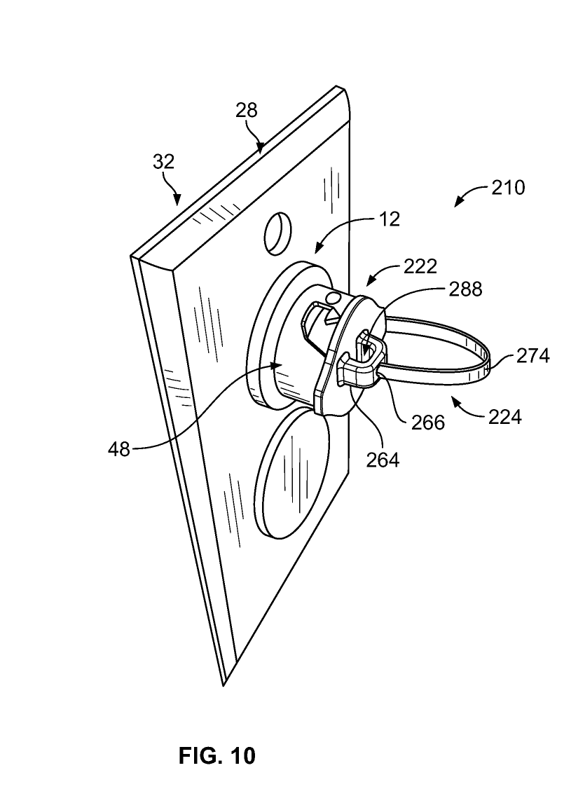

FIG. 10 is a perspective view of the electrical connector assembly 210 and the panel 28 assembled. Referring now to FIGS. 7 and 10, to assemble the electrical connector assembly 210 and mount the electrical connector assembly 210 on the panel 28, the mounting end portion 14 of the housing 48 is inserted into the opening 34 within the panel 28. The gasket 44 is optionally sandwiched between the flange 42 and the panel 28. On the side 32 of the panel 28, the fastener 26 is connected to the mounting end portion 14 of the housing 48, via the threads 36 and 38, to mount the housing 48 to the panel 28.

To mount the tether 224 to the cover 222, the tip end portion 288 of the tether 224 is inserted into the opening 266 of the cover extension 264 such that the recesses 269 each receive a portion of the extension 264 therein. Engagement between recesses 269 and the extension 264 facilitates locking the tether 224 to the cover 222. To mount the tether 24 to the housing 48, the ring 280 of the housing mount 240 is fit over the mating end portion 16 of the housing 48. The ring 280 is fit over the mating end portion 16 such that the each tab 252 of the ring 280 is received within the corresponding housing groove 50 of the housing 48. Reception of the tabs 52 within the housing grooves 50 facilitates locking the tether 224 to the housing 48 via engagement of the tabs 52 with the housing 48, and more specifically with surfaces of the housing 48 that define the housing grooves 50. The tether 224 thereby facilitates preventing the cover 222 from being lost or misplaced when removed from the housing 48.

When the tether 224 is mounted on the housing 48 and the cover 222, the oblique angle \acute{α} between the longitudinal axis 275 (FIG. 9) of the link 274 and the longitudinal tab axis 286 (FIG. 9) of the tabs 252 facilitates locking the tether 224 to the housing 48. Specifically, the oblique angle \acute{α} acts as a moment arm that provides a force in the direction D₁ of FIG. 7 to facilitate keeping the tether 224 attached to the housing 48. The force in the direction D₁ may be provided by a weight of the link 274, the cover mount 246, and/or the cover 222, and/or may be provided by an orientation of the cover mount 246 relative to the cover 222. For example, when the cover 222 is removed form the housing 48, the weight of the cover 222 provides the force in the direction D₁ to facilitate keeping the tether 224 attached to the housing 48.

The embodiments described and/or illustrated herein provide an electrical connector assembly and/or a tether that is more easily and/or less expensive to assemble and/or manufacture than at least some known tethers and electrical connector assemblies.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the description and illustrations. The scope of the subject matter described and/or illustrated herein should therefore be determined with reference to the appended claims, along with the full scope of equivalents to which such claims are entitled. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

What is claimed is:

1. An electrical connector assembly comprising:
a connector comprising a housing and a receptacle for mating with a mating connector;
a cover configured to attach to the housing; and
a tether linking the housing to the cover, wherein the tether comprises:
a housing mount for installing the tether onto the housing;
a cover mount for installing the tether onto the cover; and
a link connecting the housing mount to the cover mount, wherein the link is non-metallic.

2. The electrical connector assembly according to claim 1, wherein at least one of the housing mount and the cover mount is non-metallic.

3. The electrical connector assembly according to claim 1, wherein the link comprises an elongate strip.

4. The electrical connector assembly according to claim 1, wherein at least one of the cover mount and the housing mount comprises at least a portion of a ring.

5. The electrical connector assembly according to claim 1, wherein at least one of:
the housing mount comprises an opening for installing the housing mount on the housing; and
the cover mount comprises an opening for installing the cover mount on the cover.

6. The electrical connector assembly according to claim 1, wherein the housing comprises a mating end portion and the housing mount fits over the mating end portion of the housing.

7. The electrical connector assembly according to claim 1, wherein the cover comprises a mating end portion and the cover mount fits over the mating end portion of the cover.

8. The electrical connector assembly according to claim 1, wherein the housing comprises a housing groove and the housing mount comprises a tab configured to be received within the housing groove.

9. The electrical connector assembly according to claim 1, wherein the housing mount comprises an opening for installing the housing mount onto the housing and a tab extending generally toward a center of the opening.

10. The electrical connector assembly according to claim 1, wherein the cover comprises a cover groove and at least a portion of the cover mount is configured to be received within the cover groove.

11. The electrical connector assembly according to claim 1, wherein the cover mount comprises a recess and the cover comprises a rib that is configured to be received within the recess.

12. The electrical connector assembly according to claim 1, wherein the cover comprises an opening and the cover mount comprises a tip portion of the link, the tip portion configured to be received within the opening of the cover.

13. The electrical connector assembly according to claim 1, wherein the cover comprises an opening, the cover mount comprising a tip portion of the link, the tip portion configured to be received within the opening of the cover, the tip portion comprising a latch feature configured to latch the tip portion within the opening of the cover.

14. The electrical connector assembly according to claim 1, wherein the housing mount comprises a tab extending a length along a longitudinal tab axis, wherein the link extends a length along a longitudinal link axis that is angled obliquely relative to the longitudinal tab axis.
